(19) United States
(12) Patent Application Publication
(10) Pub. No.: US 2021/0198088 A1
(43) Pub. Date: Jul. 1, 2021

(54) Crane Block Mountable Safety Beacon Device

(71) Applicant: Angel Richarte, Henderson, NV (US)

(72) Inventor: Angel Richarte, Henderson, NV (US)

(21) Appl. No.: 16/728,610

(22) Filed: Dec. 27, 2019

(51) Int. Cl. B66C 23/90; B66C 13/16; B60Q 1/50; B66C 15/06; B60R 1/00; B60R 11/04; G08B 21/02; G08B 5/38

(52) U.S. Cl. CPC B66C 23/905; B66C 13/16; B60Q 1/50; B66C 15/065; B60R 2011/004; B60R 11/04; G08B 21/02; G08B 5/38; B60R 2300/80; B60R 1/00

(57) ABSTRACT

A crane block mountable safety beacon device for increasing awareness of a crane block includes a housing that is mountable to a crane block. A set of bulbs that is coupled to the housing selectively emits light to indicate a position of the crane block to an operator of a crane utilizing the crane block and to persons proximate to the crane block.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to safety beacon devices and more particularly pertains to a new safety beacon device for increasing awareness of a crane block.

### (2) Description of Related Art Including Information Disclosed Under 37 CFR 1.97 and 1.98

The prior art relates to safety beacon devices. Prior art safety devices for cranes may comprise a light that is attached to or proximate to the crane block that is intended to illuminate a working area around the crane, a light that is attachable to load a that is attached to the crane block, and a sensor-light combination that illuminates if a load attached to the crane block is moving.

### BRIEF SUMMARY OF THE INVENTION

An embodiment of the disclosure meets the needs presented above by generally comprising a housing that is configured to be mountable to a crane block. A set of bulbs that is coupled to the housing is configured to selectively emit light. The set of bulbs is configured to indicate a position of the crane block to an operator of a crane that is utilizing the crane block and to persons who are proximate to the crane block. The safety beacon device may be battery powered and have a solar panel to charge the battery.

The safety beacon device also may comprise an audiovisual camera and communication means to transmit an image to a monitor that is positioned proximate to the operator. The image also could be transmitted to a remote receiving station. The audiovisual camera may be activated by a motion sensor or a microphone.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a crane block mountable safety beacon device according to an embodiment of the disclosure.

FIG. 2 is a side view of an embodiment of the disclosure.

FIG. 3 is a bottom view of an embodiment of the disclosure.

FIG. 4 is an in-use view of an embodiment of the disclosure.

FIG. 5 is a top isometric perspective view of an alternative embodiment of the disclosure.

FIG. 6 is a bottom isometric perspective view of an alternative embodiment of the disclosure view of an embodiment of the disclosure.

### DETAILED DESCRIPTION OF THE INVENTION

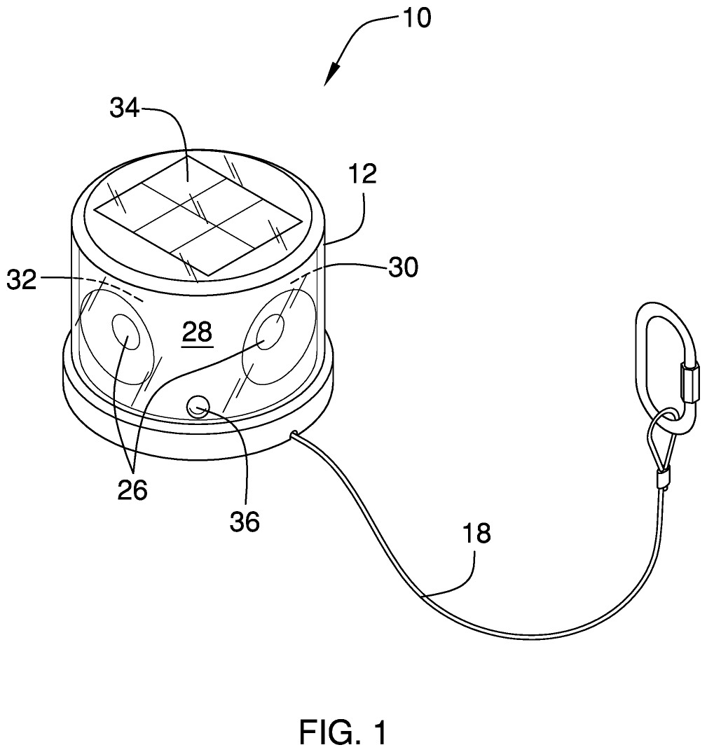

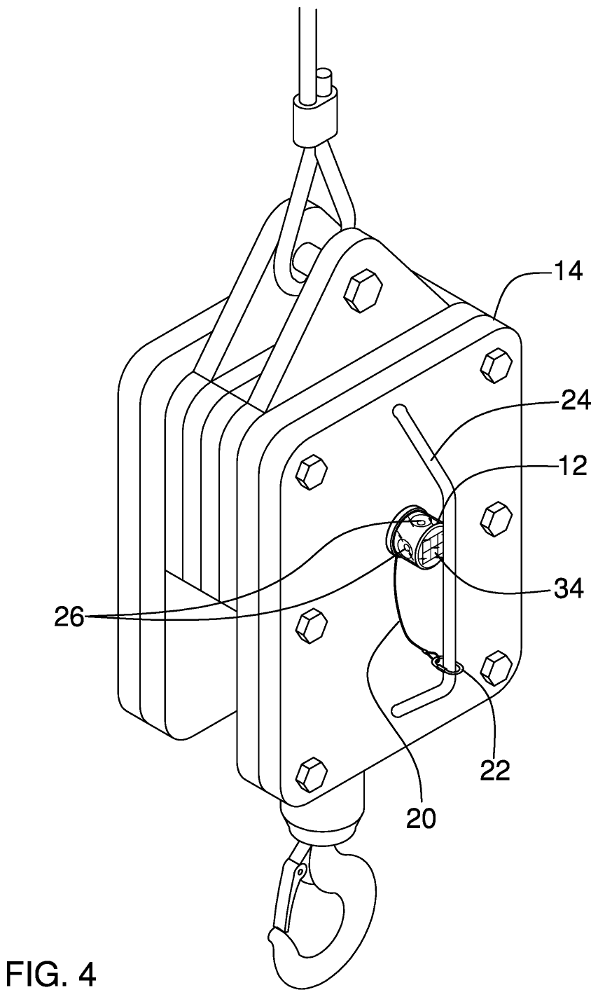

With reference now to the drawings, and in particular to FIGS. 1 through 6 thereof, a new safety beacon device embodying the principles and concepts of an embodiment of the disclosure and generally designated by the reference numeral 10 will be described.

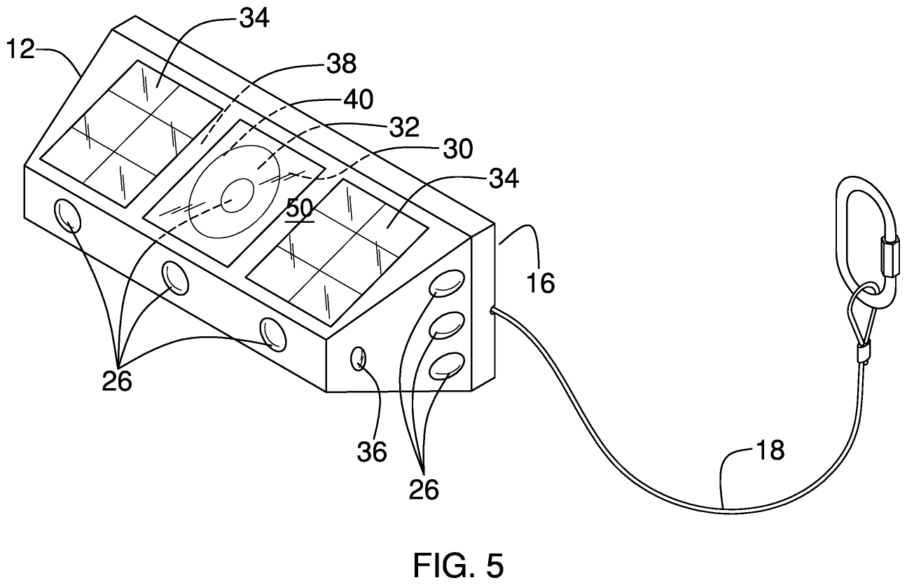

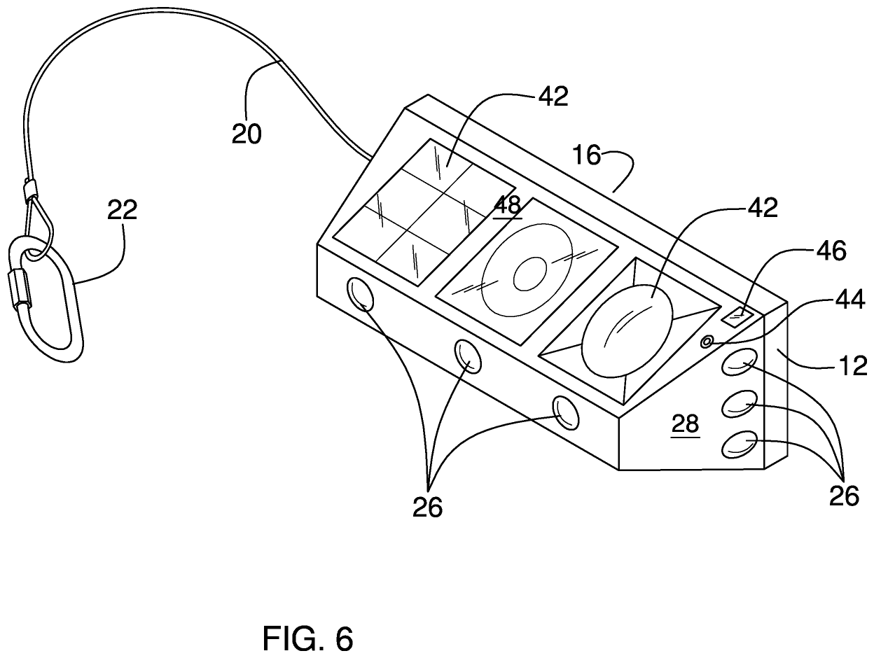

As best illustrated in FIGS. 1 through 6, the crane block mountable safety beacon device 10 generally comprises a housing 12 that is configured to be mountable to a crane block 14. The housing 12 is at least one substantially transparent, substantially opaque, blue colored, and red colored. The housing 12 may at least one of substantially cylindrically shaped, as shown in FIGS. 1-4, and substantially trapezoidally box shaped, as shown in FIGS. 5 and 6. The present invention anticipates other shapes of the housing 12, such as, but not limited to, box shaped and the like. The present invention anticipates other colors of the housing, such as, but not limited to, green, orange, and the like.

A coupler 16 that is engaged to the housing 12 is configured to reversibly engage the crane block 14. The coupler 16 is configured to removably couple the housing 12 to the crane block 14. The coupler 16 may be magnetic type, or other coupling type, such as, but not limited to, suction type, bolt type, strap type, and the like.

A fastener 18 that is engaged the housing 12 is configured to reversibly engage the crane block 14. The fastener 18 is configured to retain the housing 12 in proximity to the crane block 14 in event of failure of the coupler 16. The fastener 18 comprises a cable 20 and a connector 22. The cable 20 is coupled to and extends from the housing 12. The connector 22 is coupled to the cable 20 distal from the housing 12. The connector 22 is configured to reversibly engage an element 24 of the crane block 14 to tether the housing 12 to the element 24.

A set of bulbs 26 that is coupled to the housing 12 is configured to selectively emit light. The set of bulbs 26 is configured to indicate a position of the crane block 14 to an operator of a crane that is utilizing the crane block 14 and to persons who are proximate to the crane block 14. The present invention is anticipated to be particularly useful in conditions of low ambient light and adverse weather.

The bulbs 26 are positioned at least one of on an exterior surface 28 of the housing 12 and in an interior space 30 that is defined by the housing 12. With the bulbs 26 positioned in the interior space 30, the light emitted by the bulbs 26 is directed externally to the housing 12. The bulbs 26 may be light emitting diode type, or other type, such as incandescent, fluorescent, and the like. The bulbs 26 are configured to emit at least one of white, red, and blue light, or other color of light, such as, but not limited to, orange light, green light, and the like.

A battery 32 is coupled to the housing 12 and is positioned in the interior space 30. A solar panel 34 that is coupled to the exterior surface 28 of the housing 12 is operationally coupled to the battery 32 and thus is configured to generate an electrical current to charge the battery 32.

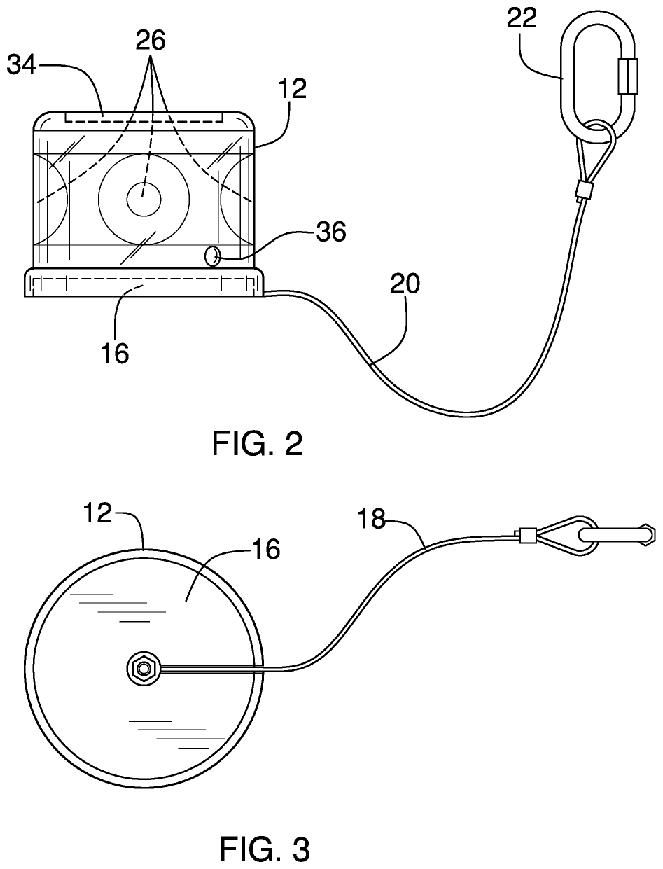

A controller 36 that is coupled to the housing 12 is configured to selectively actuate the bulbs 26 for constant and intermittent illumination. The controller 36 may be push button type, as shown in FIG. 2, or other type, such as multibutton selector type, dial type, and the like. The controller 36 is configured to be depressed a first time to actuate the bulbs 26 for constant illumination, a second time to actuate the bulbs 26 for intermittent illumination, and a third time to depower the bulbs 26.

In another embodiment of the invention, as shown in FIGS. 5 and 6, the device 10 is configured to capture an audiovisual image of an area that is proximate to the housing 12. A microprocessor 38 and a transmitter 40 are coupled to the housing 12 and are positioned in the interior space 30. The microprocessor 38 is operationally coupled to the battery 32, the set of bulbs 26, and the transmitter 40.

A camera 42, a microphone 44, and a sensor 46 are coupled to the housing 12, with the camera 42 being positioned on a lower face 48 of the housing 12. In this embodiment, the solar panel 34 is positioned on an upper face 50 of the housing 12. The camera 42, the microphone 44, and the sensor 46 are operationally coupled to the microprocessor 38. The camera 42 is configured to capture the audiovisual image of the area that is proximate to the housing 12 and the microprocessor 38 is positioned to actuate the transmitter 40 to transmit the audiovisual image to at least one of a monitor (not shown) that is positioned in an operator cab of the crane and a remote receiving station (not shown).

The microphone 44 is configured to detect a noise proximate to the housing 12, positioning the microphone 44 to signal the microprocessor 38 of a noise event. The microprocessor 38 thus is positioned to actuate the camera 42 to capture the audiovisual image and the transmitter 40 to transmit the audiovisual image to the at least one of the monitor and the remote receiving station.

The sensor 46 is motion type and is configured to detect motion proximate to the housing 12, positioning the sensor 46 to signal the microprocessor 38 of a motion event. The microprocessor 38 thus is positioned to actuate the camera 42 to capture the audiovisual image and the transmitter 40 to transmit the audiovisual image to the at least one of the monitor and the remote receiving station.

In use, the housing 12 is magnetically engaged to the crane block 14. The fastener 18 also is engaged to the crane block 14 as a backup to the coupler 16. The controller 36 is used to select between constant and intermittent illumination of the bulbs 26. The audiovisual camera 42 of the alternative embodiment is actuated when the microphone 44 detects noise or when the sensor 46 detects motion and captures the audiovisual image.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A crane block mountable safety beacon device comprising:
a housing configured to be mountable to a crane block;
a set of bulbs coupled to the housing and configured for selectively emitting light, wherein the set of bulbs is configured for indicating a position of the crane block to an operator of a crane utilizing the crane block and to persons proximate to the crane block;
a battery coupled to the housing and positioned in an interior space defined by the housing;
a microprocessor coupled to the housing and positioned in the interior space, the microprocessor being operationally coupled to the battery and the set of bulbs;
a controller coupled to the housing and configured for selectively actuating the bulbs for constant and intermittent illumination, wherein the controller is push button type such that the controller is configured for depressing a first time for actuating the bulbs for constant illumination, a second time for actuating the bulbs for intermittent illumination, and a third time for depowering the bulbs; and
a solar panel coupled to an exterior surface of the housing, the solar panel being operationally coupled to the battery, wherein the solar panel is configured for generating an electrical current for charging the battery.

2. The crane block mountable safety beacon device of claim 1, wherein:
the housing is substantially opaque;
the bulbs are positioned on an exterior surface of the housing; and
the bulbs are configured for emitting at least one of red and blue light.

3. The crane block mountable safety beacon device of claim 1, wherein:
the housing is at least one of blue colored and red colored;
the bulbs are positioned in an interior space defined by the housing such that light emitted by the bulbs is directed externally to the housing; and
the bulbs are configured for emitting white light.

4. The crane block mountable safety beacon device of claim 1, wherein:
the housing is substantially transparent;
the bulbs are positioned in an interior space defined by the housing such that light emitted by the bulbs is directed externally to the housing; and
the bulbs are configured for emitting at least one of red and blue light.

5. The crane block mountable safety beacon device of claim 1, wherein the bulbs are light emitting diode type.

6. The crane block mountable safety beacon device of claim 1, further including a coupler engaging the housing and configured for reversibly engaging the crane block, wherein the coupler is configured for removably coupling the housing to the crane block.

7. The crane block mountable safety beacon device of claim 6, wherein the coupler is magnetic type.

8. The crane block mountable safety beacon device of claim 6, further including a fastener engaging the housing and configured for reversibly engaging the crane block, wherein the fastener is configured for retaining the housing in proximity to the crane block in event of failure of the coupler, the fastener comprising a cable and a connector, the cable being coupled to and extending from the housing, the connector being coupled to the cable distal from the housing, the connector being configured for reversibly engaging an element of the crane block for tethering the housing to the element.

9. The crane block mountable safety beacon device of claim 1, further including the housing being at least one of substantially cylindrically shaped and substantially trapezoidally box shaped.

10. (canceled)

11. The crane block mountable safety beacon device of claim 9, further including:
the housing being substantially trapezoidally box shaped;
a transmitter coupled to the housing and positioned in the interior space, the transmitter being operationally coupled to the microprocessor;
a camera coupled to a lower face of the housing, the camera being operationally coupled to the microprocessor, wherein the camera is configured for capturing an audiovisual image of an area proximate to the housing, positioning the microprocessor for actuating the transmitter for transmitting the audiovisual image to at least one of a monitor positioned in an operator cab of the crane and a remote receiving station.

12. The crane block mountable safety beacon device of claim 11, further including a microphone coupled to the housing, the microphone being operationally coupled to the microprocessor, wherein the microphone is configured for detecting a noise proximate to the housing, positioning the microphone for signaling the microprocessor of a noise event, positioning the microprocessor for actuating the camera for capturing the audiovisual image and the transmitter for transmitting the audiovisual image to the at least one of the monitor positioned in the operator cab and the remote receiving station.

13. The crane block mountable safety beacon device of claim 11, further including a sensor coupled to the housing, the sensor being motion type, the sensor being operationally coupled to the microprocessor, wherein the sensor is configured for detecting motion proximate to the housing, positioning the sensor for signaling the microprocessor of a motion event, positioning the microprocessor for actuating the camera for capturing the audiovisual image and the transmitter for transmitting the audiovisual image to the at least one of the monitor positioned in the operator cab and the remote receiving station.

14. A crane block mountable safety beacon device comprising:
a housing configured to be mountable to a crane block, the housing being at least one substantially transparent, substantially opaque, blue colored, and red colored, the housing being at least one of substantially cylindrically shaped and substantially trapezoidally box shaped;
a coupler engaging the housing and configured for reversibly engaging the crane block, wherein the coupler is configured for removably coupling the housing to the crane block, the coupler being magnetic type;
a fastener engaging the housing and configured for reversibly engaging the crane block, wherein the fastener is configured for retaining the housing in proximity to the crane block in event of failure of the coupler, the fastener comprising a cable and a connector, the cable being coupled to and extending from the housing, the connector being coupled to the cable distal from the housing, the connector being configured for reversibly engaging an element of the crane block for tethering the housing to the element;
a set of bulbs coupled to the housing and configured for selectively emitting light, wherein the set of bulbs is configured for indicating a position of the crane block to an operator of a crane utilizing the crane block and to persons proximate to the crane block, the bulbs being positioned at least one of on an exterior surface of the housing and in an interior space defined by the housing such that light emitted by the bulbs is directed externally to the housing, the bulbs being light emitting diode type, the bulbs being configured for emitting at least one of white, red, and blue light;
a battery coupled to the housing and positioned in the interior space;
a microprocessor coupled to the housing and positioned in the interior space, the microprocessor being operationally coupled to the battery and the set of bulbs;
a transmitter coupled to the housing and positioned in the interior space, the transmitter being operationally coupled to the microprocessor;
a camera coupled to a lower face of the housing, the camera being operationally coupled to the microprocessor, wherein the camera is configured for capturing an audiovisual image of an area proximate to the housing, positioning the microprocessor for actuating the transmitter for transmitting the audiovisual image to at least one of a monitor positioned in an operator cab of the crane and a remote receiving station;
a microphone coupled to the housing, the microphone being operationally coupled to the microprocessor, wherein the microphone is configured for detecting a noise proximate to the housing, positioning the microphone for signaling the microprocessor of a noise event, positioning the microprocessor for actuating the camera for capturing the audiovisual image and the transmitter for transmitting the audiovisual image to the at least one of the monitor positioned in the operator cab and the remote receiving station;
a sensor coupled to the housing, the sensor being motion type, the sensor being operationally coupled to the microprocessor, wherein the sensor is configured for detecting motion proximate to the housing, positioning the sensor for signaling the microprocessor of a motion event, positioning the microprocessor for actuating the camera for capturing the audiovisual image and the transmitter for transmitting the audiovisual image to the at least one of the monitor positioned in the operator cab and the remote receiving station;
a controller coupled to the housing and configured for selectively actuating the bulbs for constant and intermittent illumination, the controller being push button type wherein the controller is configured for depressing a first time for actuating the bulbs for constant illumination, a second time for actuating the bulbs for intermittent illumination, and a third time for depowering the bulbs; and
a solar panel coupled to an exterior surface of the housing, the solar panel being operationally coupled to the battery, wherein the solar panel is configured for generating an electrical current for charging the battery.

15. A crane block and safety beacon device combination comprising:
a crane block having a housing mounted thereto;
a set of bulbs coupled to the housing and configured for selectively emitting light, wherein the set of bulbs is configured for indicating a position of the crane block to an operator of a crane utilizing the crane block and to persons proximate to the crane block;
the housing being substantially trapezoidally box shaped;
a battery coupled to the housing and positioned in an interior space defined by the housing;
a microprocessor coupled to the housing and positioned in the interior space, the microprocessor being operationally coupled to the battery and the set of bulbs;
a transmitter coupled to the housing and positioned in the interior space, the transmitter being operationally coupled to the microprocessor;
a camera coupled to a lower face of the housing, the camera being operationally coupled to the microprocessor, wherein the camera is configured for capturing an audiovisual image of an area proximate to the housing, positioning the microprocessor for actuating the transmitter for transmitting the audiovisual image to at least one of a monitor positioned in an operator cab of the crane and a remote receiving station;
a microphone coupled to the housing, the microphone being operationally coupled to the microprocessor, wherein the microphone is configured for detecting a noise proximate to the housing, positioning the microphone for signaling the microprocessor of a noise event, positioning the microprocessor for actuating the camera for capturing the audiovisual image and the transmitter for transmitting the audiovisual image to at least one of a monitor positioned in an operator cab and a remote receiving station; and
a sensor coupled to the housing, the sensor being motion type, the sensor being operationally coupled to the microprocessor, wherein the sensor is configured for detecting motion proximate to the housing, positioning the sensor for signaling the microprocessor of a motion event, positioning the microprocessor for actuating the camera for capturing the audiovisual image and the transmitter for transmitting the audiovisual image to the at least one of the monitor positioned in the operator cab and the remote receiving station; and
a controller coupled to the housing and configured for selectively actuating the bulbs for constant and intermittent illumination, the controller being push button type wherein the controller is configured for depressing a first time for actuating the bulbs for constant illumination, a second time for actuating the bulbs for intermittent illumination, and a third time for depowering the bulbs.

16. (canceled)

17. (canceled)

18. (canceled)

19. (canceled)

20. The crane block and safety beacon device combination of claim 15, further including a solar panel coupled to an exterior surface of the housing, the solar panel being operationally coupled to the battery, wherein the solar panel is configured for generating an electrical current for charging the battery.
